(19) United States
(12) Patent Application Publication
(10) Pub. No.: US 2014/0343870 A1
(43) Pub. Date: Nov. 20, 2014

(54) DETERMINATION OF ACCEPTOR AND DONOR DOPANT CONCENTRATIONS

(71) Applicant: COMMISSARIAT À L'ENERGIE ATOMIQUE ET AUX ENERGIES ALTERNATIVES, Paris (FR)

(72) Inventors: Benoît MARTEL, Gilly sur Isere (FR); Jordi VEIRMAN, Poisy (FR)

(73) Assignee: COMMISSARIAT À L'ENERGIE ATOMIQUE ET AUX ENERGIES ALTERNATIVES, Paris (FR)

(21) Appl. No.: 14/277,512

(22) Filed: May 14, 2014

(30) Foreign Application Priority Data
May 14, 2013 (FR) 13 01104

(51) Int. Cl. G01N 27/72

(52) U.S. Cl. CPC G01N 27/72
USPC 702/23

(57) ABSTRACT

The concentrations of three acceptor and donor dopants of a semiconductor sample are determined by solving a system of three equations. A first equation is obtained by measuring the free charge carrier concentration of the sample at low temperature, and in then confronting these measurements with a mathematical model suitable for these temperatures. A second equation is obtained by measuring a mobility of the majority charge carriers and comparing it with its mathematical expression. A third equation between the dopant concentrations is established knowing the activation energy of the shallower majority dopant in the bandgap of the semiconductor material. When the activation energy of this majority dopant is equal to its maximum value, this third equation is derived from the electro-neutrality of the silicon at ambient temperature. When, the activation energy differs from its maximum value, the concentration of this majority dopant can be deduced directly from its activation energy.

### BACKGROUND OF THE INVENTION

The invention relates to determination of the dopant concentrations in a semiconductor material, particularly in a metallurgical grade silicon sample intended for use in the photovoltaic industry.

### STATE OF THE ART

Upgraded Metallurgical Grade Silicon (UMG-Si) is commonly used in the photovoltaic industry. It is preferred to Electronic Grade Silicon (EG-Si) as the methods for producing it are less expensive and require less energy. This enables the fabrication costs of photovoltaic cells to be reduced.

Metallurgical Grade Silicon does on the other hand contain more impurities than Electronic Grade Silicon. The dopant concentrations, of boron and phosphorus in particular, are particularly high (several ppma).

Boron atoms constitute dopant impurities of acceptor type whereas phosphorus atoms constitute dopant impurities of donor type. As Metallurgical Grade Silicon contains both types of dopant impurities, it is considered as being compensated in dopant impurities.

Fabrication of photovoltaic cells from UMG-Si wafers requires stringent control of the dopant contents. The acceptor and donor dopant concentrations do in fact have an influence on the electrical properties of the cells, such as the conversion efficiency.

It therefore appears important to know the dopant concentrations in the silicon, in particular to determine whether additional purification steps are necessary. It is also useful to know the dopant concentrations in the silicon feedstock used to fabricate a silicon ingot. This information then enables the photovoltaic cell fabrication methods to be optimized.

The dopant concentrations of a silicon sample are conventionally determined by Glow Discharge Mass Spectroscopy (GDMS) or by Inductively Coupled Plasma Mass Spectrometry (ICPMS). However, these chemical analysis techniques are slow and lack precision for samples having low dopant concentrations.

Determination of the dopant concentrations can also be performed by the supplier of the silicon ingot on completion of crystallization of the latter. Various techniques can be used.

The document [“Segregation and crystallization of purified metallurgical grade silicon: Influence of process parameters on yield and solar cell efficiency”, B. Drevet et al., 25^{th} European PV Solar Energy Conference and Exhibition, Valencia, 2010] describes a method for determining the dopant concentrations in a metallurgical grade silicon ingot. A step consists in detecting the transition between a p-conductivity and an n-conductivity, which occurs at a certain height h_{eq} in the ingot. The electrical resistivity ρ is then measured at the bottom end of the ingot, i.e. in the area corresponding to the beginning of solidification. The parameters h_{eq} and ρ are then input to an equation derived from Scheil's law to determine the concentration profiles in the ingot.

In Patent application FR2978548, the height h_{eq} of the change of conductivity type (p-n transition) in a metallurgical grade silicon ingot and the concentration of free charge carriers at the bottom end of the ingot are measured. Relations derived from Scheil's law then enable the dopant concentrations in the whole ingot to be determined, the segregation coefficients of the dopants in the metallurgical grade silicon being known.

These techniques require crystallization of an ingot by directional solidification. They are therefore not applicable to silicon wafers. Furthermore, they require the transition between p-type and n-type to be detected precisely. This step is however difficult to reproduce on a large scale as the position of this transition varies greatly from one ingot to another. This transition height can also vary in the same ingot, making extraction of the dopant concentrations more imprecise.

Furthermore, the article [“Electrical characterization of epitaxial layers”, G. E. Stillman et al., Thin Solid Films, 31, 69-88, 1976] discloses a technique for determining the concentrations of donor atoms N_{D} and acceptor atoms N_{A} in a GaAs sample of n-conductivity type. To determine the concentrations N_{D} and N_{A}, a theoretical expression of the charge carrier concentration versus the temperature is adjusted to experimental values measured by Hall effect. This theoretical expression involves the use of the activation energy E_{D} of the donors, which form the majority in an n-type sample.

Several chemical species sometimes happen to be responsible for the same type of doping. For example, a compensated silicon sample can contain two sorts of acceptor dopants (p-doped), boron and aluminium, and a donor dopant, phosphorus (p-doped).

In this case, the technique of the above-mentioned article and that of Patent application FR2978548 do not enable the aluminium and boron concentrations to be determined independently, only the total concentration of acceptor type impurities being able be determined. In other words, the boron cannot be distinguished from the aluminium. In particular, as aluminium is an impurity that is both dopant and metallic, it presents a recombinant nature and it is useful to know its proper concentration in order to eliminate it in the course of purification.

Likewise, when the sample comprises several sorts of donor dopants, for example phosphorus and arsenic, it is not possible to isolate the phosphorus concentration and the arsenic concentration.

### SUMMARY OF THE INVENTION

A requirement exists to provide a quick and precise method for determining each of the dopant concentrations of acceptor and donor type in a semi-conductor material sample when the latter comprises several dopants of the same type.

More particularly, it is required to know the dopant concentrations in a sample containing three dopants, one of majority type and one of minority type, two dopants of the same type having different activation energies.

This requirement tends to be met by means of the following steps:
measuring the free charge carrier concentration in the sample at first and second temperatures for which the dopant of majority type having the weakest activation energy is in an ionization state;
comparing the measurements of the free charge carrier concentration with a mathematical model of the free charge carrier concentration versus the temperature in the ionization state;
determining the value of the activation energy of the dopant of majority type having the weakest activation energy and establishing a first equation between the dopant concentrations from parameters of the mathematical model;
determining an experimental value of the mobility of the majority charge carriers in the sample, preferably at ambient temperature;
comparing the experimental value of the majority charge carrier mobility with a theoretical expression of the mobility so as to establish a second equation between the dopant concentrations; and
comparing the value of the activation energy of the dopant of majority type having the weakest activation energy with a threshold value of the activation energy for said dopant.

When said activation energy value is lower than the threshold value, the three dopant concentrations are determined from the weakest activation energy and from the first and second equations.

When said activation energy value is equal to the threshold value, the three dopant concentrations are determined from the first and second equations, from a third equation derived from the electro-neutrality in the semiconductor material at ambient temperature and from the free charge carrier concentration at ambient temperature.

What is means by “dopant” is a chemical species inserted in the semi-conductor material in order to modify its electrical conduction properties. The dopant impurities designate the atoms of the dopant element.

Doping generates charge carriers in the semiconductor material: holes in the case of an acceptor dopant and electrons in the case of a donor dopant. When the number of holes generated is larger than the number of electrons, the holes are said to be “majority” and the electrons are said to be “minority”. By extension, the acceptor dopants are qualified as being of majority type and the donor dopants are qualified as being of minority type.

Inversely, when the number of holes generated is smaller than the number of electrons, the holes (acceptor dopants) are said to be “minority” and the electrons (donor dopants) are said to be “minority”.

Finally, the expression “free charge carriers” encompasses both the majority charge carriers and the minority charge carriers. The concentration of free charge carriers corresponds to the net doping: the difference between the concentration of majority charge carriers and the concentration of minority charge carriers.

The mathematical model of the free charge carrier concentration versus the temperature in the ionization state is preferably an Arrhenius law.

If the semiconductor material sample comprises two majority dopants and one minority dopant, the model can be written:

$${p}_{0} ( T ) = C \cdot [ \frac{{N}_{MF} - {N}_{m}}{{N}_{m}} ] \cdot {e}^{\frac{- {E}_{MF}}{kT}}$$

with C a coefficient representative of a type of conductivity of the majority dopants, N_{MF} the concentration of the majority dopant having the weakest activation energy E_{MF}, Nₘ the concentration of the minority dopant in the sample, k the Boltzmann's constant and T the temperature.

If the semiconductor material sample comprises two minority dopants and one majority dopant, the model can be written:

$${p}_{0} ( T ) = C \cdot [ \frac{{N}_{M} - ( {N}_{m 1} + {N}_{m 2} )}{( {N}_{m 1} + {N}_{m 2} )} ] \cdot {e}^{\frac{- {E}_{M}}{kT}}$$

with C a coefficient representative of a type of conductivity of the majority dopant, N_{M} the concentration of the majority dopant in the sample, E_{M} the activation energy of the majority dopant, Nₘ₁ and Nₘ₂ the concentrations of the two minority dopants in the sample, k the Boltzmann's constant and T the temperature.

Preferably, the experimental value of the mobility is determined from the resistivity of the sample measured at a third temperature and from the free charge carrier concentration measured at the third temperature.

Advantageously, the free charge carrier concentration and the resistivity are respectively measured by Hall effect and by the Van der Pauw method.

### BRIEF DESCRIPTION OF THE DRAWINGS

Other advantages and features will become more clearly apparent from the following description of particular embodiments of the invention given for non-restrictive

example purposes only and illustrated by means of the appended drawings, in which:

FIG. 1 schematically represents the energy levels introduced by two donor dopants and two acceptor dopants in the silicon bandgap;

FIG. 2 represents steps of a method for determining the dopant concentrations according to the invention, applied to a sample containing two majority acceptor dopants and one minority donor dopant;

FIG. 3 represents a preferred embodiment of step F2 of FIG. 2;

FIG. 4 represents the activation energy of a majority dopant versus the concentration of this majority dopant, for n-type and p-type silicon samples;

FIG. 5 represents steps of a method for determining the dopant concentrations according to the invention, applied to a sample containing one majority acceptor dopant and two minority donor dopants; and

FIGS. 6 to 8 are examples of curve plots representing the logarithm of the free charge carrier concentration versus the inverse of the temperature.

### DESCRIPTION OF A PREFERRED EMBODIMENT OF THE INVENTION

In the following description, a semiconductor material sample, for example a metallurgical grade silicon, comprising three dopant impurity species is considered. This sample is compensated in dopant impurities. In other words, at least one dopant is of electron acceptor type and at least one dopant is of electron donor type.

Under these conditions, two configurations are possible: either the sample comprises two acceptor dopants (boron and aluminium for example) and one donor dopant (for example phosphorus or arsenic), or it comprises two donor dopants and one acceptor dopant.

The two dopants of the same type, acceptor or donor depending on the case, are different chemical species. They introduce more or less deep energy levels, defined by their electrical energy activation, in the silicon bandgap. This energy activation will subsequently enable them to be differentiated.

Furthermore, when the acceptor atom concentration is greater than the donor atom concentration, all the species being taken into consideration, the acceptors are called “majority” and the donors are called “minority”. The conductivity of the sample is then of p-type. Inversely, when the donor atom concentration is greater than the acceptor atom concentration, the donor dopants are majority compared with the acceptor dopants and the sample is of n-type.

Naturally, in the presence of a single acceptor dopant (respectively donor dopant), the latter can however be majority if the concentration of this dopant is greater than the sum of the two donor (respectively acceptor) dopant concentrations.

Two other cases therefore arise for each distribution of the donor and acceptor dopants, according to the conductivity type of the sample which results from the doping.

Whatever the nature of the dopants and the type of conductivity, the three dopant concentrations of the sample can be determined by solving a system of three equations in which their respective concentrations are input.

A first equation is obtained by measuring the free charge carrier concentration of the sample (the holes in the p-type, and the electrons in the n-type) at low temperature, and by then confronting these measurements with a mathematical model suitable for these temperatures.

In similar manner, a second equation is obtained by measuring the mobility of the majority charge carriers and by comparing it with its theoretical expression.

Finally, a third condition on the dopant concentrations can be established knowing the activation energy of the shallower majority dopant in the bandgap of the semiconductor material. When the activation energy of this majority dopant is equal to its maximum value, this third condition is based on the electro-neutrality of silicon at ambient temperature. On the other hand, when the activation energy differs from its maximum value, the concentration of this majority dopant can be directly deduced from its activation energy.

This method for determining the dopant concentrations is described in detail in the following, in the different cases set out below.

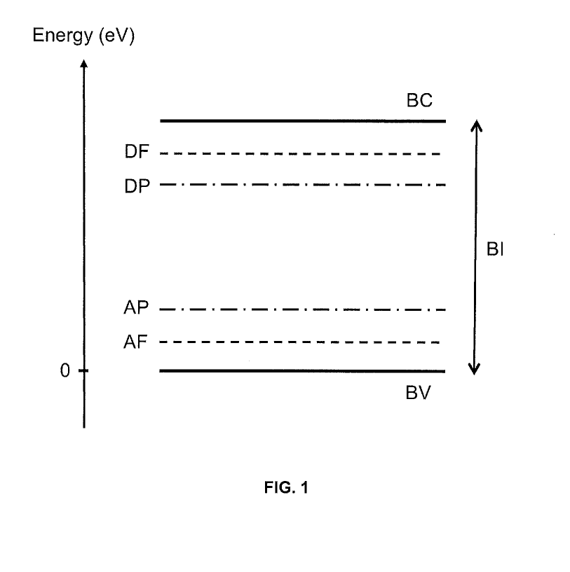

To start with, FIG. 1 illustrates the notion of more or less deep dopant by a band structure plot.

The case of a silicon comprising two donor dopants is represented at the top of the band structure, near the conduction band BC. The shallower dopant donor, noted “DF” is the one whose energy level (represented by a dashed line) inserted in the bandgap BI of the silicon is closer to the conduction band. The dopant “DP” is a deeper dopant donor as its energy level (represented by a dotted and dashed line) is farther away from the conduction band BC.

In similar manner, for two acceptor dopants “AF” and “AP”, the shallower acceptor dopant “AF” is the one whose energy level is the closer to the valence band. This energy level is represented by a dashed line, at the bottom of the band structure of FIG. 1. “AP” designates the dopant the energy level of which is inserted deeply into the silicon gap (represented by a dotted and dashed line).

The activation energy of a donor (respectively acceptor) dopant corresponds to the energy difference (in eV) between the conduction band (respectively the valence band) and the energy level of the dopant. The activation energies of the acceptor and donor dopants hereafter have positive values (the valence band defines the origin of the axis of the energies in FIG. 1).

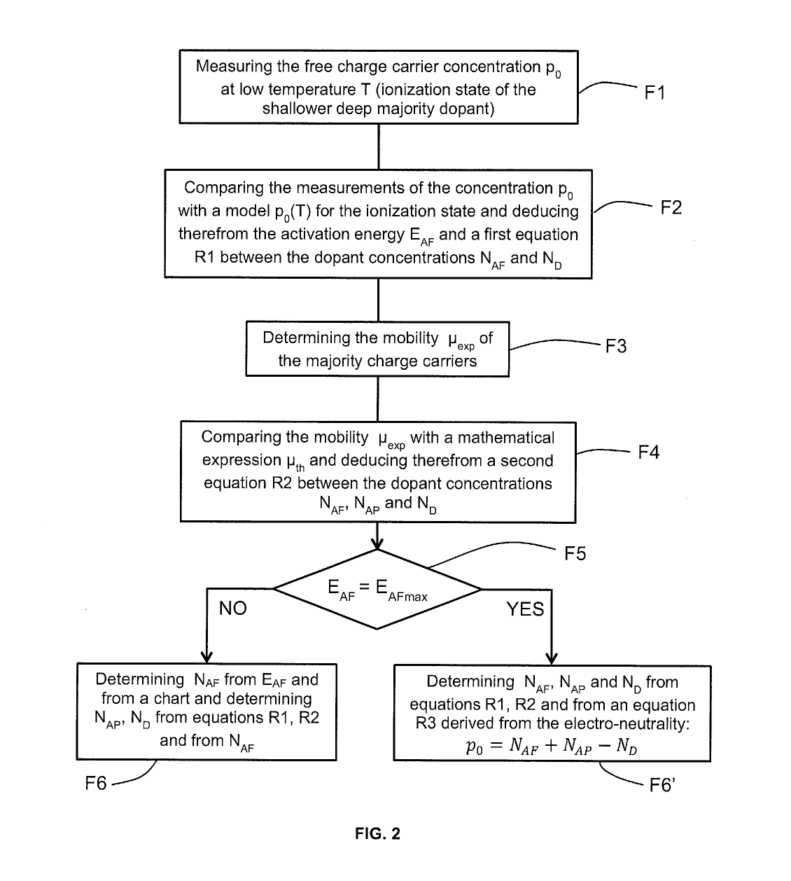

FIG. 2 represents an embodiment of the method for determining the dopant concentrations in the case of a p-type silicon containing a donor dopant, for example phosphorus, and two acceptor dopants, for example boron and aluminium.

N_{AF} and E_{AF} respectively designate the concentration and the activation energy of the acceptor dopant having the shallower level, i.e. the activation energy having the lower value (boron in the above example). N_{AP} is the concentration of the acceptor dopant having the higher activation energy value, E_{AP} (for example aluminium). Finally, the concentration of donor atoms (for example phosphorus) in the silicon sample is noted N_{D}.

In a first step F1 of the method, the free charge carrier concentration p₀ (net doping) is measured at low temperature.

In a p-type silicon, the free charge carriers are holes. Their number is given by the relation:

p₀=ΣN_{A}⁻−N_{D}⁺ (1)

in which N_{A}⁻ is the concentration of ionized atoms of each acceptor dopant (boron and aluminium) and N_{D}⁺ is the concentration of ionized donor atoms (phosphorus).

When the temperature of the silicon sample decreases, the majority dopants, here the acceptors, are progressively “frozen”. The acceptor atoms become electrically inactive as the thermal energy is no longer sufficient to ionize these impurities. It is on the other hand considered that the minority dopants, here the donors, are all active, whatever the temperature of the sample (N_{D}⁺=N_{D}).

Freezing of the majority dopants is performed by temperature steps according to the energy levels introduced by the impurities in the silicon bandgap. At low temperature, the acceptor impurities whose energy level is deep are neutralized, as the thermal energy necessary for their ionization is high. Then, at very low temperature, the acceptor atoms whose energy level is less deep are in turn neutralized.

Measurement step F1 of FIG. 2 is performed at low temperature to temporarily discard the acceptor dopant having the higher energy E_{AP} from calculation of the concentration of holes p₀ (relation 1). This enables a relation to be established linking only the concentration N_{AF} and the concentration N_{D} to the concentration of holes p₀. In this temperature range, the concentration of ionized and deep acceptor atoms is in fact zero. The concentration of holes p₀ of relation (1) becomes equal to the difference of the concentration of the ionized shallow acceptor atoms, which will be noted N_{AP}⁻, and of the concentration of donor atoms N_{D}:

p₀=N_{AF}⁻−N_{D} (1′).

In step F1, the concentration of holes p₀ is measured at two temperatures at least for which the shallow acceptor dopant, in this instance the boron, is in an ionization state. This state is characterized by a partial and not total ionization of the boron atoms. The concentration of ionized boron atoms N_{AF} is then lower than the concentration of boron atoms N_{AF} and varies according to the temperature T.

The Hall effect is preferably used for measuring the free charge carrier concentration. Measurement by Hall effect first enables the Hall carrier concentration p_{H} to be determined from a voltage measurement. Then the concentration p₀ is calculated from the concentration p_{H} by applying a correction coefficient r_{H} called Hall factor.

In step F2, the measurements of the concentration p₀ are confronted with a mathematical model p₀(T) specific to this ionization state.

The model p₀(T) preferably uses an Arrhenius law derived from the relation (1′) and from the Fermi-Dirac statistic. It is written in the form

$$A . {e}^{\frac{- B}{kT}} \text{:}$$

$${p}_{0} ( T ) = \frac{1}{4} \cdot {N}_{V} \cdot [ \frac{{N}_{AF} - {N}_{D}}{{N}_{D}} ] \cdot {e}^{\frac{- {E}_{AF}}{kT}}$$

The pre-exponential factor

$$A = \frac{1}{4} \cdot {N}_{V} \cdot [ \frac{{N}_{AF} - {N}_{D}}{{N}_{D}} ]$$

takes account of the concentration N_{AF} of shallow acceptor atoms, of the concentration N_{D} of donor atoms (all ionized) and of the state density N_{V} in the valence band. The parameter B figuring in the exponential is equivalent to the activation energy E_{AF} of the shallow acceptor dopant.

Cross-checking of the experimental values of the concentration p₀ with the above theoretical expression (step F2) fixes a value for each of the parameters A and B of the model. A first equation R1 linking the dopant concentrations N_{AF} and N_{D} (the expression of the factor A), and also the activation energy E_{AF} (factor B) can both be deduced therefrom.

On account of the fact that the model p₀(T) is an Arrhenius law, a simple and fast manner for implementing step F2 can consist in studying the linear relation between the logarithm of the free charge carrier concentration p₀ and the inverse of the temperature T.

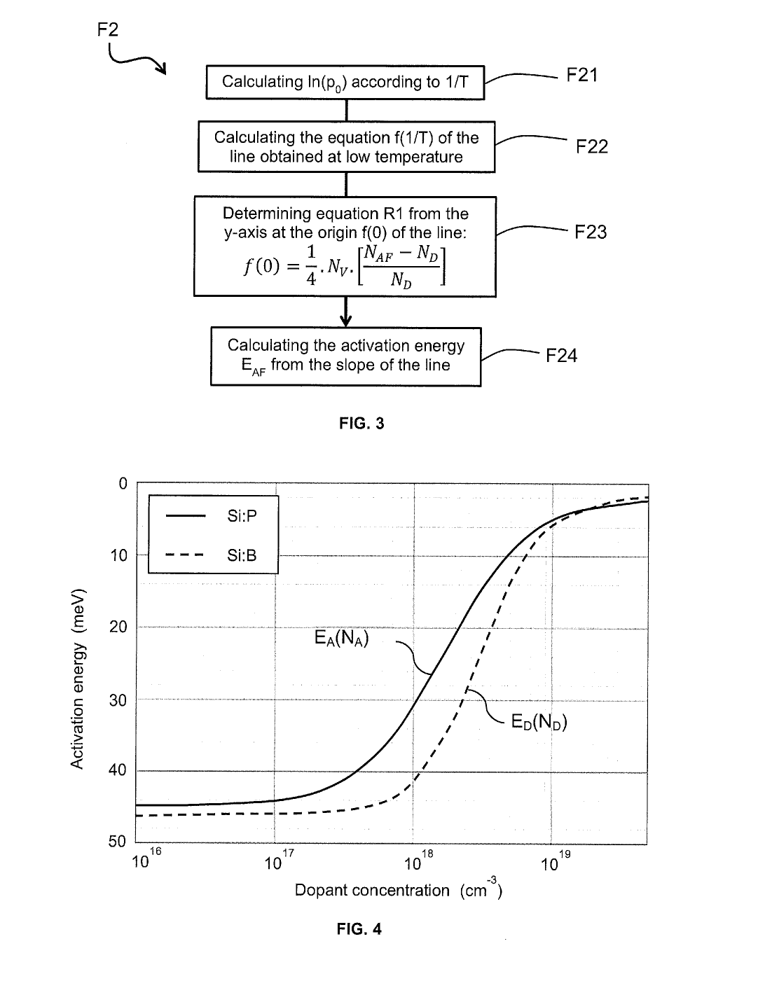

FIG. 3 represents this advantageous implementation mode of step F2 via steps F21 to F24.

In step F21, the logarithm of the concentration p₀ versus the inverse of the temperature T is calculated for the different values of p₀ measured in step F1.

In step F22, the equation y=f(x) of a line representing the logarithm of the concentration p₀ in the ionization state of the shallow acceptor dopant is calculated. Two items of information are then available: the y-axis at the origin f(0), which contains the concentrations N_{AF} and N_{D}, and the slope of this line which is proportional to the activation energy E_{AF}.

Equation R1 can be deduced directly from the y-axis at the origin f(0) (step F23):

$$f ( 0 ) = \frac{1}{4} \cdot {N}_{V} \cdot [ \frac{{N}_{AF} - {N}_{D}}{{N}_{D}} ] \qquad ( R 1 )$$

In step F24, the activation energy E_{AF} is calculated by dividing the slope of the line by the Boltzmann's constant k.

Although two temperature measurements in the ionization state are sufficient for establishment of equation R1, it may be preferable to perform a multitude of measurements over a larger temperature range, in particular a measurement at ambient temperature.

The method for determining of FIG. 2 also comprises a step F3 of determining the mobility αₑₓₚ of the majority charge carriers in the sample (FIG. 1). To establish the second equation between the dopant concentrations N_{AF}, N_{AP} and N_{D}, the measured value of the mobility is compared, in a step F4, with a mathematical expression αₜₕ of the mobility which makes use of the concentrations N_{AF}, N_{AP} and N_{D}.

The mathematical expression of the mobility αₜₕ can be determined based on a theoretical model originating from a scientific theory. In this case, the term theoretical expression can be referred to. Furthermore, this mathematical expression can be determined from values based on experimental works. In other words, the mathematical expression of the mobility can also be obtained in empirical or semi-empirical manner.

The mobility depends on the free charge carrier concentration p₀ and on the resistivity ρ of the sample in the following manner:

$$μ ( T ) = \frac{1}{{p}_{0} ( T ) \cdot q \cdot ρ ( T )}$$

q being the elementary electric charge (q=1.6*10⁻¹⁹ C).

Thus, in a preferred embodiment of step F3, the mobility value αₑₓₚ is calculated from the resistivity p of the sample and from the concentration p₀ measured at the same temperature.

If it is desired to reuse one of the previous measurements of the concentration p₀ (those of step F1), the resistivity ρ is measured at one of the temperatures corresponding to the ionization state. This will however require new cooling of the sample, unless the resistivity ρ was measured at the same time as the concentration p₀ during step F1, which is generally the case.

It may therefore be more convenient to perform resistivity measurement at another temperature, in particular at ambient temperature. Thus, in an alternative embodiment, the resistivity ρ and the hole concentration p₀ of the sample are both measured at ambient temperature.

Preferably, the technique used for measuring the resistivity ρ is the Van der Pauw technique. Other resistivity measurement techniques could nevertheless be envisaged: by Foucault current or by the “4-point probes” method.

The variations of the mobility of the majority carriers according to the dopant contents in the compensated silicon have been the subject of numerous studies and several mobility models have been proposed. For example, the authors of the article [“Modeling majority carrier mobility in compensated crystalline silicon for solar cells”, F. Schindler et al., Solar Energy Materials & Solar Cells, vol. 106, pp. 31-36, 2012] developed the following model:

$$μ = {μ}_{min} + \frac{{μ}_{max} - {μ}_{min}}{1 + {( \frac{N}{{N}_{ref}} )}^{α} + {( \frac{{C}_{l} - 1}{{C}_{l , ref}} )}^{β}}$$

wherein αₘᵢₙ, μₘₐₓ, N_{ref}, α, β, C_{l,ref} are constants of the model. N is the sum of the dopant concentrations (N=N_{AF}+N_{AP}+N_{D}). Cₗ is the degree of compensation as defined by the relation:

$${C}_{l} = \frac{N}{{N}_{AF} + {N}_{AP} - {N}_{D}}$$

This model, developed in the context of a compensated p-type silicon, can easily be adapted into the case of n-type silicon. Alternatively, other models of the literature could be used in the determination method (provided they include the three concentrations).

In step F4 of FIG. 2, the experimental value μₑₓₚ of the mobility is equated with its mathematical expression. A second equation R2 is then obtained linking the dopant concentrations N_{AF}, N_{AP} and N_{D} (via the total dopant concentration N and the degree of compensation Cₗ):

$${μ}_{exp} = {μ}_{min} + \frac{{μ}_{max} - {μ}_{min}}{1 + {( \frac{N}{{N}_{ref}} )}^{α} + {( \frac{{C}_{l} - 1}{{C}_{l , ref}} )}^{β}} \qquad ( R2 )$$

The third condition enabling the concentrations N_{AF}, N_{AP} and N_{D} to be determined depends on the value of the activation energy E_{AF} calculated in step F2. It has in fact been shown in the document [“A simulation model for the density of states and for incomplete ionization in crystalline silicon—Part II”, P. P. Altermatt et al., J. Appl. Phys. 100, 113715, 2006] that the activation energy of the majority impurities varies with the concentration N_{A} of these majority impurities.

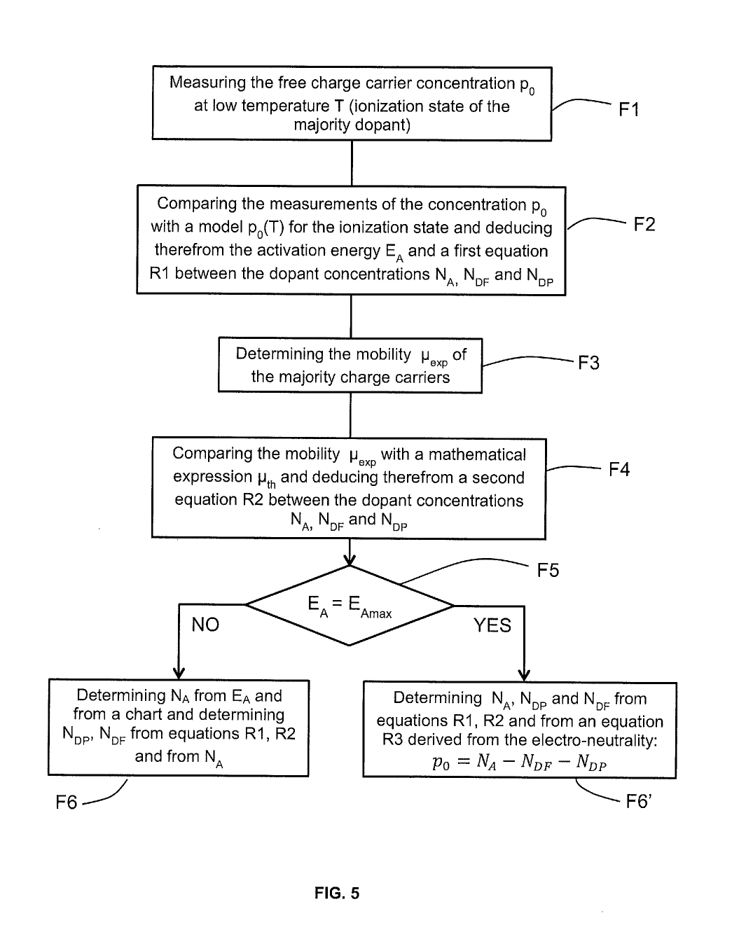

FIG. 4 represents this variation of the activation energy in the case of a silicon predominantly doped with boron (p-type), i.e. the energy of the acceptor dopants E_{A} versus the concentration of acceptors N_{A}, and in the case of a silicon predominantly doped with phosphorus (n-type), i.e. the function E_{D}(N_{D}).

It can be observed in FIG. 4 that the activation energy E_{A} of the acceptor dopant reaches a maximum value E_{Amax} when the dopant concentration N_{A} is low. However, above a certain concentration threshold N_{A}, situated at about 10¹⁷ atoms/cm⁻³ of boron, it decreases. This is due to the fact that the energy level introduced by the majority impurities switches from a discrete state to a band state when the dopant concentration increases, this band approaches the valence band.

This observation is also valid for n-conductivity, as represented in FIG. 4 (with the difference that the “band” energy level is close to the conduction band).

Furthermore, P. P. Altermatt et al. showed that the ionization rate of the majority impurities at ambient temperature (about 300 K) is in the vicinity of 100% for the concentrations N_{A} of the plateau E_{A}=E_{Amax} of FIG. 4, i.e. for concentrations lower than 10¹⁷ cm⁻³.

In the method according to FIG. 2, these observations are implemented to obtain a third item of information on the dopant concentrations.

When the activation energy E_{AF} calculated in step F2 differs from the threshold value E_{AFmax}, there is only one possible value for the corresponding concentration N_{AF} on the graph of FIG. 4. Thus, when this condition is verified, the concentration N_{AF} of shallow acceptor dopants can be determined directly by means of a chart such as that of FIG. 4.

When the activation energy E_{AF} is equal to the threshold value E_{AFmax}, the dependence between E_{AF} and N_{AF} illustrated by FIG. 4 cannot on the other hand be used, as a plurality of concentrations N_{AF} corresponding to the energy E_{AFmax} exist (plateau area). Instead, the electro-neutrality law given by relation (1) at ambient temperature is used, assuming a complete ionization of the acceptor (and donor) dopants.

When the assumption of a complete ionization at ambient temperature is in fact justified (E_{AF}=E_{AFmax}), the following relation applies:

p₀(T_{ambient})=N_{AF}+N_{AP}−N_{D} (R3)

In other words, whereas P. P. Altermatt merely ascertain a complete ionization of the majority impurities at ambient temperature, the determination method uses this observation as a working assumption to develop a third equation R3 between the dopant concentrations.

In the method according to FIG. 2, a step F5 is provided to compare the value of the activation energy E_{AF} calculated in step F2 with its threshold value E_{AFmax}.

If the activation energy E_{AF} differs from E_{AFmax} (NO output of step F5), the concentration N_{AF} of shallow acceptors is determined as indicated above in a step F6, and the donor concentration N_{D} is then determined by means of the equation R1, and the deep acceptor concentration N_{AP} is finally determined by means of the remaining equation R2.

If the activation energy E_{AF} is equal to E_{AFmax} (YES output of step F5), a system of three equations with three unknowns is then obtained with the above equation R3, which can be easily resolved for example by means of a computer (step F6′).

Although steps F1 to F4 appear to be successive in FIG. 2, the method for determining the dopant concentrations is not limited to any particular order of these steps. For example, measurement steps F1 and F3 can be performed simultaneously.

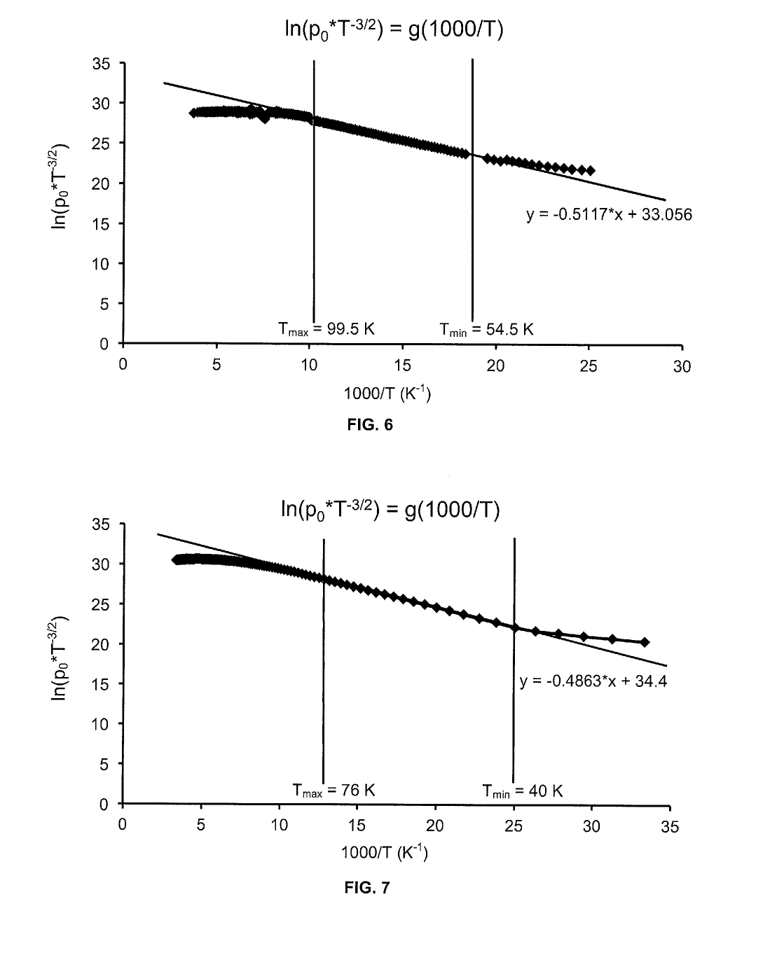

FIG. 5 represents an alternative embodiment of the method for determining the dopant concentrations in the case of a silicon of p-conductivity type henceforth containing a single acceptor dopant, but two donor dopants.

The concentration and energy of the single (but majority) acceptor dopant are therein noted N_{A} and E_{A}. The two donor dopants, of concentrations N_{DF}, N_{DP} will be differentiated by their activation energy: E_{DP} for the greater energy (deeper dopants) and E_{DF} for the weaker energy (shallower dopants).

This variant establishes and solves equations between the dopant concentrations N_{A}, N_{DF} and N_{DP} in the same way as according to the embodiment of FIG. 2. The steps of the method of FIG. 5 are therefore, in substance, the same as those of FIG. 2. Only the writing of equations R1 to R3 differs.

The two donor dopants are minority in the p-type. They are consequently all ionized, whatever the temperature. The concentration of holes p₀ is then written:

p₀=N_{A}⁻−N_{DF}−N_{DP}

The measurements of the concentration p₀ for temperatures corresponding to the ionization state of the single acceptor dopant (step F1) are confronted with a mathematical model suitable for this new case (step F2), which is as follows:

$${p}_{0} ( T ) = \frac{1}{4} \cdot {N}_{V} \cdot [ \frac{{N}_{A} - {N}_{DF} - {N}_{DP}}{{N}_{DF} + {N}_{DP}} ] \cdot {e}^{\frac{- {E}_{A}}{kT}}$$

The first equation can, as previously, be taken from the logarithm of the concentration of holes p₀ (y-axis at the origin of the line) and is henceforth written:

$$f ( 0 ) = \frac{1}{4} \cdot {N}_{V} \cdot [ \frac{{N}_{A} - {N}_{DF} - {N}_{DP}}{{N}_{DF} + {N}_{DP}} ] \qquad ( R1 )$$

The second equation is, as previously, obtained by comparing the experimental value of the mobility with a mathematical expression μₜₕ (steps F3-F4). This expression is similar to the previous expression. Only the degree of compensation Cₗ has to be redefined:

$${C}_{l} = \frac{N}{{N}_{A} - {N}_{DP} - {N}_{DF}}$$

henceforth with N=N_{A}+N_{DP}+N_{DF}.

Finally, depending on the value of the activation energy E_{A} of the majority acceptor dopant (step F5), either a chart E_{A}(N_{A}) is used to deduce the concentration N_{A} directly therefrom (step F6), or, the value of the concentration of holes p₀ at ambient temperature being known, the electro-neutrality equation at ambient temperature is used (step F6′):

p₀(T_{ambient})=N_{A}−N_{DF}−N_{DP} (R3)

For a compensated n-type silicon (majority donor dopants), the method for determining will be applied in identical manner, except of course as far as writing of the equations between the different dopant concentrations is concerned. Furthermore, in step F1, it is no longer the concentration of holes p₀ that is measured, but the concentration of electrons n₀ (the electrons are majority). In steps F3 and F5, the activation energy E_{D} (or E_{DF} if there are two) of the dopant donor that is not frozen at low temperature is considered.

Table 1 below sets out all the equations necessary for determination of the dopant concentrations for an n-type silicon. Two cases can again be distinguished:
two acceptor dopants and one donor dopant: {N_{AF}, N_{AP}, N_{D}}; or
two donor dopants and one acceptor dopant: {N_{A}, N_{DF}, N_{DP}}.

TABLE 1

| | {N_{AF}, N_{AP}, N_{D}} | {N_{A}, N_{DF}, N_{DP}} |
|---|---|---|
| R1 | ${n}_{0} ( T ) = \begin{matrix}\frac{1}{2} \cdot {N}_{C} \cdot \\ [ \frac{\begin{matrix}{N}_{D} - {N}_{AF} - \\ {N}_{AP}\end{matrix}}{{N}_{AF} + {N}_{AP}} ] \cdot {e}^{\frac{- {E}_{D}}{kT}}\end{matrix}$ with N_{C} the state density in the conduction band | ${n}_{0} ( T ) = \begin{matrix}\frac{1}{2} \cdot {N}_{C} \cdot \\ [ \frac{{N}_{DF} - {N}_{A}}{{N}_{A}} ] \cdot {e}^{\frac{- {E}_{DF}}{kT}}\end{matrix}$ with N_{C} the state density in the conduction band |
| R2 | $\begin{matrix}{μ}_{exp} = {μ}_{min} + \frac{{μ}_{max} - {μ}_{min}}{\begin{matrix}1 + {( \frac{N}{{N}_{ref}} )}^{α} + \\ {( \frac{{C}_{l} - 1}{{C}_{l , ref}} )}^{β}\end{matrix}} \\ with N = {N}_{D} + {N}_{AF} + {N}_{AP} \\ and {C}_{l} = \frac{N}{{N}_{D} - {N}_{AP} - {N}_{AF}}\end{matrix}$ | $\begin{matrix}{μ}_{exp} = {μ}_{min} + \frac{{μ}_{max} - {μ}_{min}}{\begin{matrix}1 + {( \frac{N}{{N}_{ref}} )}^{α} + \\ {( \frac{{C}_{l} - 1}{{C}_{l , ref}} )}^{β}\end{matrix}} \\ with N = {N}_{DF} + {N}_{DP} + {N}_{A} \\ and {C}_{l} = \frac{N}{{N}_{DF} + {N}_{DP} - {N}_{A}}\end{matrix}$ |
| R3 | n₀(T_{amb}) = N_{D} − N_{AF} − N_{AP} | n₀(T_{amb}) = N_{DF} + N_{DP} − N_{A} |

The mobility model of F. Schindler et al. (relation R2) is also applicable to n-conductivity type, provided that the values of the parameters μₘᵢₙ, μₘₐₓ, N_{ref}, α, β, C_{l,ref} are adjusted.

The method described above determines the dopant concentrations of a semiconductor sample in reliable and precise manner. Unlike techniques of the prior art, it enables the distinction to be made between several dopant species responsible for the same type of doping. It further applies to all forms of samples, in particular ingots or wafers. The different computing steps of the determination method can be performed by means of a computer, and more particularly by a microprocessor.

These different dopant concentrations constitute precious information for optimizing fabrication methods of semiconductor devices. In particular, fabrication of high-efficiency photovoltaic cells from metallurgical grade silicon is facilitated, as it is henceforth possible to efficiently control their dopant concentrations.

In order to be more precise on determination of the activation energy of the shallow majority dopant (E_{A}/E_{AF} or E_{DF}/E_{D} depending on the type of doping) and on the relation R1, the temperature variation of the parameter N_{V} or N_{C} can be taken into account. The state densities N_{V} and N_{C} are functions of the temperature T, in T^{3/2} whatever the type of semiconductor and of doping. The logarithm of the concentration p(T) multiplied by T^{-3/2} can then be plotted to take account of this dependence.

As indicated in the foregoing, the ionization state of the shallower majority dopant corresponds to a certain temperature range. This temperature range varies according to the nature of the dopants, their concentration and naturally the semiconductor material.

It is observed that the upper limit of this range, i.e. the temperature at which the change takes place from a saturation state of the majority dopant to an ionization state, increases the higher the concentration of majority dopants. Furthermore, the more the sample is compensated, the more the concentration increases. This is valid for both an n-doped semiconductor and for a p-doped semiconductor.

For a given material and doping, the upper limit of the temperature range can be determined experimentally by plotting the logarithm of the free charge carrier concentration versus the inverse of the temperature, and by observing at what temperature the curve switches from a hyperbolic behaviour to a linear behaviour. It can also be determined numerically by calculating the variation of the carriers according to the temperature (in particular by means of relation 1).

The lower limit of the range corresponds to the occurrence of a conduction phenomenon called “hopping”. Indeed, at very low temperature, conduction of the electrons in the conduction band (or of the holes in the valence band) becomes so improbable that it leaves the way open for another mechanism: hopping of the charge carriers between energy states located in the bandgap of the silicon. The charge carriers hop from atom to atom, among the ionized majority dopants.

The lower limit of the temperature range thus corresponds to the transition between the band conduction state (frozen state of the deep dopants) and the conduction state by hopping. It can be determined by plotting the logarithm of the free charge carrier concentration and by observing a second hyperbolic behaviour, at very low temperature. Alternatively, it can be determined by plotting the resistivity curve as an Arrhenius law (resistivity versus the inverse of the temperature) and by noting the temperature at which the linear state comes to an end (for example by making a linear regression).

When the free charge carrier concentration is measured by Hall effect, the lower temperature limit is advantageously determined by plotting the curve of the Hall coefficient

$$( {R}_{H} = \frac{1}{{p}_{0} ( T ) \cdot q} )$$

versus the reverse of the temperature, and in then noting where the end of the linear state takes place.

In the following examples, the concentrations of acceptor and donor dopants obtained by the method according to the invention are compared with the values obtained by the conventional Glow Discharge Mass Spectroscopy (GDMS) method.

### Example 1

In this first example, the sample is made from p-type compensated silicon. It contains two dopant species of acceptor type, boron and gallium, and a dopant species of donor type, phosphorus.

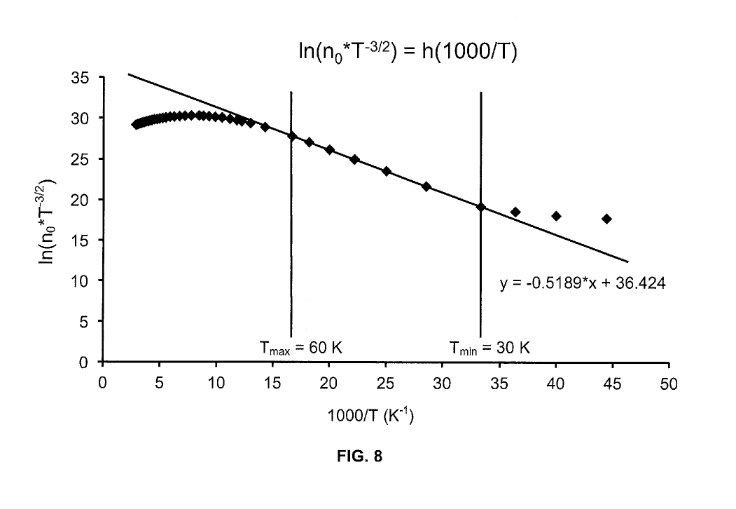

The concentration of holes p₀ is measured by Hall effect in a 40 K-300 K temperature range. The values of the logarithm of the concentration of holes ln(p₀)*T^{-3/2} are recorded on the graph of FIG. 6 versus the inverse of the temperature 1000/T. The curve of the logarithm presents a linear portion from a temperature threshold Tₘₐₓ, which is estimated by linear regression (Tₘₐₓ=99.5 K). The linear state is terminated at the temperature Tₘᵢₙ, also estimated by linear regression (Tₘᵢₙ=54.5 K).

A line is thus obtained in a 54.5 K-99.5 K temperature range (the values of Tₘₐₓ and Tₘᵢₙ correspond to sharp variations of the linear regression coefficient). Its equation is the following: y=−0.512*x+33.06.

On the one hand, the slope of the line enables the activation energy E_{AF} of the boron, which inserts the weakest energy level in the silicon bandgap, to be calculated: E_{AF}=44 meV.

The y-axis at the origin enables the ratio of the boron concentration over the phosphorus concentration to be calculated:

$$ln [ \frac{1}{4} \cdot {N}_{V}^{′} \cdot ( \frac{[ B ] - [ P ]}{[ P ]} ) ] = 33.06$$

N_{V}′ is a state density in the valence band the temperature contribution of which has been eliminated by plotting of ln(p₀*T^{-3/2}): N_{V}=N_{V}′·T^{3/2}, with N_{V}′=3.5*10¹⁵ cm⁻³.

The hole concentration at ambient temperature (300 K) is equal to 1.1*10¹⁶ cm⁻³. After the resistivity of the sample has been measured, the mobility αₑₓₚ of the holes at ambient temperature is then deduced therefrom:

$$\begin{matrix}{μ}_{exp} = {μ}_{min} + \frac{{μ}_{max} - {μ}_{min}}{1 + {( \frac{N}{{N}_{ref}} )}^{α} + {( \frac{{C}_{l} - 1}{{C}_{l , ref}} )}^{β}} \\ = 308.52 {cm}^{2} * {V}^{- 1} * {s}^{- 1}\end{matrix}$$

As the value of 44 meV is very close to the stable and discrete level of the boron in the bandgap of the silicon (45 meV), the hypothesis of an ionization rate of close to 100% at ambient temperature is valid. This enables the electro-neutrality equation to be used as third and last equation:

[B]+[Ga]−[P]=1.1*10¹⁶ cm⁻³

The dopant concentrations, calculated by solving the above three equations (step F6′), are set out in table 2 followed for comparison purposes by the values measured by GDMS:

TABLE 2

| | Method | GDMS |
|---|---|---|
| [B] | 3.01*10¹⁶ | 2.54*10¹⁶ |
| [Ga] | 5.67*10¹⁵ | 6.75*10¹⁵ |
| [P] | 2.41*10¹⁵ | 2.22*10¹⁶ |

A close fit exists between the values measured by GDMS chemical analysis and those obtained by the determining method of FIG. 1.

### Example 2

In this second example, the sample is also p-type compensated silicon, but comprises aluminium instead of gallium.

The hole concentration p₀ is measured, also by Hall effect, in the 30 K-300 K temperature range and the resistivity of the sample is measured at 300 K. Curve plot ln(p₀)*T^{-3/2} versus 1000/T, represented in FIG. 7, presents in the 40 K-76 K range a line having the equation: y=−0.486*x+34.41.

The activation energy E_{AF} is then equal to 41.8 meV, which is lower than the maximum value of the activation energy observed for boron (45 meV). The value of the boron concentration is in this case obtained directly by means of a chart E_{AF}(N_{AF}), such as that of FIG. 3:

[B]=1.11*10¹⁷ cm⁻³

The y-axis at the origin of the line and the boron concentration being known, the phosphorus concentration is determined:

$$\begin{matrix}[ P ] = \frac{[ B ]}{\frac{4 \cdot {e}^{34.41}}{{Nv}^{′}} + 1} \\ = 5.64 * {10}^{16} {cm}^{- 3}\end{matrix}$$

Finally, the value of the majority carrier mobility at ambient temperature is estimated at 260.5 cm²*V⁻¹·s⁻¹. The mathematical expression μₜₕ of the mobility enables the aluminium concentration to be calculated from the boron and phosphorus concentrations.

[Al]=5.57*10¹⁶ cm⁻³

TABLE 3

| | Method | GDMS |
|---|---|---|
| [B] | 1.11*10¹⁷ | 10¹⁷ |
| [Al] | 5.57*10¹⁶ | 6*10¹⁶ |
| [P] | 5.64*10¹⁶ | 5*10¹⁶ |

The values obtained by the method of FIG. 2 (step F6) are again close to those obtained by GDMS chemical analysis.

### Example 3

The last example concerns a sample of n-type silicon doped with phosphorus, boron and aluminium.

The electron concentration nₒ is measured by Hall effect between 20 K and 350 K. In the 30 K-60 K range, the function h such that ln(p₀)*T^{-3/2}=h(1000/T) describes a line of equation y=−0.521*x+36.46 (FIG. 8). The activation energy of the phosphorus (majority dopant) is equal to 44.6 meV, which corresponds to the maximum energy level observed for this dopant.

The mobility of the electrons at 300 K is measured at 872 cm²·V⁻¹·s⁻¹. The electron concentration at 300 K is equal to 3.2*10¹⁶ cm⁻³.

The following equations are deduced therefrom:

$$ln [ ( \frac{1}{2} \cdot {N}_{C}^{′} ( \frac{[ P ] - [ B ] - [ Al ]}{[ B ] + [ Al ]} ) ] = 36.46$$

N_{C}′ is a state density in the conduction band the temperature contribution of which has been eliminated by plotting of ln(p₀*T⁻³¹²): N_{C}=N_{C}′·T^{3/2} with N_{C}′=5.4*10¹⁵ cm⁻³.

$$\begin{matrix}{μ}_{exp} = {μ}_{min} + \frac{{μ}_{max} - {μ}_{min}}{1 + {( \frac{N}{{N}_{ref}} )}^{α} + {( \frac{{C}_{l} - 1}{{C}_{l , ref}} )}^{β}} \\ = 872 {cm}^{2} \cdot {V}^{- 1} \cdot {s}^{- 1}\end{matrix} \\ [ P ] - [ B ] - [ Al ] = 3.2 * {10}^{16} {cm}^{- 3}$$

TABLE 4

| | METHOD | GDMS |
|---|---|---|
| [P] | 3.58*10¹⁶ | 4*10¹⁶ |
| [B] | 6.8*10¹⁵ | 5*10¹⁵ |
| [Al] | 3.3*10¹⁵ | 3*10¹⁵ |

Table 4 gives the dopant concentrations obtained by solving the system of the three above equations. Thus, for both n-conductivity and p-conductivity type, the values obtained by the determination method are in accordance with those of the conventional GDMS technique.

1. A method for determining dopant concentrations in a semiconductor material sample, the sample comprising three dopants one of which is of majority type and one of minority type, two dopants of the same type having different activation energies, the method comprising the following steps:
measuring the free charge carrier concentration in the sample at first and second temperatures for which the dopant of majority type having the weakest activation energy is in an ionization state;
confronting the measurements of the free charge carrier concentration with a mathematical model of the free charge carrier concentration versus the temperature in the ionization state;
determining the value of the activation energy of the dopant of majority type having the weakest activation energy and establishing a first equation between the three dopant concentrations from parameters of the mathematical model;
determining an experimental value of the mobility of the majority charge carriers in the sample;
comparing the experimental value of the mobility of the majority charge carriers with a mathematical expression of the mobility so as to establish a second equation between the dopant concentrations;
comparing the value of the activation energy of the dopant of majority type having the weakest activation energy with a threshold value of the activation energy for said dopant;
determining the three dopant concentrations from said activation energy value, and from the first and second equations, when said activation energy value is lower than the threshold value; or
determining the three dopant concentrations from the first and second equations, and from a third equation derived from the electro-neutrality in the semiconductor material at ambient temperature and from the free charge carrier concentration measured at ambient temperature, when said activation energy value is equal to the threshold value.

2. The method according to claim 1, wherein the model of the free charge carrier concentration versus the temperature in the ionization state is an Arrhenius law.

3. The method according to claim 2, wherein the semiconductor material sample comprises two majority dopants and one minority dopant, and wherein the model of the free charge carrier concentration p₀(T) is written:
$${p}_{0} ( T ) = C \cdot [ \frac{{N}_{MF} - {N}_{m}}{{N}_{m}} ] \cdot {e}^{\frac{- {E}_{MF}}{kT}}$$
with C a coefficient representative of a type of conductivity of the majority dopants, N_{MF} the concentration of the majority dopant having the weakest activation energy E_{MF}, Nₘ the concentration of the minority dopant in the sample, k the Boltzmann's constant and T the temperature.

4. The method according to claim 2, wherein the semiconductor material sample comprises two minority dopants and one majority dopant, and wherein the model of the free charge carrier concentration p₀(T) is written:
$${p}_{0} ( T ) = C \cdot [ \frac{{N}_{M} - ( {N}_{m 1} + {N}_{m 2} )}{( {N}_{m 1} + {N}_{m 2} )} ] \cdot {e}^{\frac{- {E}_{M}}{kT}}$$
with C a coefficient representative of a type of conductivity of the majority dopant, N_{M} the concentration of the majority dopant in the sample, E_{M} the activation energy of the majority dopant, Nₘ₁ and Nₘ₂ the concentrations of the two minority dopants in the sample, k the Boltzmann's constant and T the temperature.

5. The method according to claim 2, comprising the following steps:
calculating the logarithm of the free charge carrier concentration versus the inverse of the temperature from measurements of the free charge carrier concentration,
calculating the equation of a line representing the logarithm of the free charge carrier concentration in the ionization state;
determining the value of the activation energy of the dopant of majority type having the weakest activation energy from the slope of the line and determining the equation between the three dopant concentrations from the y-axis at the origin of the line.

6. The method according to claim 1, wherein the experimental value of the mobility is determined from the resistivity of the sample measured at a third temperature and from the free charge carrier concentration measured at the third temperature.

7. The method according to claim 6, wherein the resistivity is measured by the Van der Pauw method.

8. The method according to claim 1, wherein the free charge carrier concentration is simultaneously measured by Hall effect.
